(19) United States
(12) Patent Application Publication
(10) Pub. No.: US 2020/0386206 A1
(43) Pub. Date: Dec. 10, 2020

(54) METHOD FOR FORECASTING THE YIELD OF WIND FARMS UNDER ICING CONDITIONS

(71) Applicant: FOS4X GMBH, Munchen (DE)

(72) Inventors: Thomas Schauss, Gilching (DE); Markus SCHMID, Munchen (DE)

(21) Appl. No.: 16/760,867

(22) PCT Filed: Oct. 22, 2018
(86) PCT No.: PCT/EP2018/078906

§ 371 Date: Apr. 30, 2020

(30) Foreign Application Priority Data
Oct. 30, 2017 (DE) 10 2017 125 457.9

(51) Int. Cl. F03D 7/04; F03D 80/40; G01W 1/10

(52) U.S. Cl. CPC F03D 7/046; F03D 80/40; F05B 2260/84; G01W 1/10; F05B 2260/8211; F03D 7/048

(57) ABSTRACT

The invention relates to a method for creating a prediction model for ice build-up on wind turbines. The method comprises: detecting ice build-up data at at least one wind turbine; using meteorological data for the location of the at least one wind turbine; feeding in the ice build-up data of the at least one wind turbine and the meteorological data in a machine learning method; and creating a prediction model based on the machine learning method. The invention also relates to a method for predicting ice build-up on wind turbines. The method comprises: detecting ice build-up data at at least one wind turbine; using meteorological data for the location of the at least one wind turbine; and predicting an ice build-up based on a machine-learned model.

### TECHNICAL FIELD

Embodiments of the present disclosure relate to a method for creating a prediction model for ice build-up on wind turbines, and a method of predicting an ice build-up on wind turbines.

### STATE OF THE ART

Rotor blades of wind turbines are exposed to the meteorological conditions of the environment in an unprotected manner. At certain locations, ice may accumulate at the rotor blades in case of correspondingly low environmental temperatures and sufficiently high air humidity or when rainfall occurs. With the increasing size of rotor blades of wind turbines, their surface area increases so that also the risk of ice accumulating, i.e. the formation of an ice build-up on the rotor blades, increases.

Ice accumulations, on the one hand, represent a potential danger to the environment of the wind turbine, since in the event of the ice build-up being dropped—during operation or at standstill of the turbine the dropped ice pieces may endanger persons or objects in the dropping radius. On the other hand, an imbalance of the rotor of the wind turbine may come about in particular when ice is accumulated unevenly, which might result in damages during the operation of the wind turbine. Furthermore, continuous ice accumulation may lead to the fact that the entire plant is stopped. This is normally accompanied by losses of yield and economic disadvantages.

It is known to evaluate data of a wind turbine so as to draw conclusions as to the danger of already occurred accumulations of ice. DE 10 2005 016 524 A1 discloses a method for detecting ice on a wind turbine, in which both meteorological conditions relating to icing conditions, and one or more physical characteristics of the wind turbine during operation are monitored which allow a change of mass of the rotor blades of the wind turbine to be concluded.

Furthermore, yield forecasts in the state of the art usually are based on weather models. The yield of a wind turbine is in this case determined as a function of the expected wind velocity, wind direction, temperature, air humidity, etc. together with relevant plant parameters (especially, the performance curve). In part, historical data is also used to determine a more accurate model for a wind turbine. In addition, scheduled maintenance assignments may be incorporated in the yield forecast. A dedicated use of icing forecasts usually is not included.

US 2012/0226485 A1 describes a method for predicting the probability of ice formation or accumulation on rotor blades of wind turbines. The method utilizes, inter alia, the historical measurement of meteorological data such as wind speed, temperature, and relative humidity.

US2014/0244188 A1 describes a method and an apparatus for forecasting the power of a wind turbine in a wind farm, wherein a corrected data set based on environmental data collected from a sensor in a wind farm is used to improve a weather forecasting model.

Especially in winter, icing events in, e.g., rotor blades of individual wind turbines occur repeatedly in wind farms. Often, wind turbines in wind farms need to be stopped as a consequence. This results in yield losses to the wind farm operators due to a reduced availability of the turbines.

### SUMMARY

Embodiments of the present disclosure provide a method for creating a prediction model for ice build-up on wind turbines. Furthermore, embodiments of the present disclosure provide a method of predicting ice build-up on wind turbines.

According to one embodiment, a method for creating a prediction model for ice build-up on wind turbines is proposed including detecting ice build-up data at at least one wind turbine; using meteorological data for the location of the at least one wind turbine; feeding in the ice build-up data of the at least one wind turbine and the meteorological data in a machine learning method; and creating a prediction model based on the machine learning method.

According to a further embodiment, a method for predicting ice build-up on wind turbines is proposed, including detecting ice build-up data at at least one wind turbine; using meteorological data for the location of the at least one wind turbine, and predicting an ice build-up based on a machine-learned model.

According to further embodiments, a use of the methods described herein is provided for creating a yield forecast for at least one wind turbine, in particular for at least one wind turbine of a wind farm.

### BRIEF DESCRIPTION OF THE DRAWINGS

Exemplary embodiments are illustrated in the drawings and explained in more detail in the following description. In the drawings:

FIG. 1A schematically shows by way of example three wind farms according to embodiments described herein;

FIG. 1B schematically shows by way of example a wind farm with three wind turbines according to embodiments described herein;

FIG. 2A schematically shows a part of a wind turbine with rotor blades and sensors according to embodiments described herein;

FIG. 2B schematically shows a rotor blade of a wind turbine with a sensor according to embodiments described herein;

FIG. 3 shows a flow chart of a first method according to embodiments described herein;

FIG. 4 shows a flow chart of a second method according to embodiments described herein;

FIG. 5A shows a flow chart of a method according to embodiments described herein;

FIG. 5B shows a flow chart of a method according to embodiments described herein;

FIG. 6 schematically shows a light conductor with a fiber Bragg grating for use in sensors according to embodiments described herein;

FIG. 7 schematically shows a measurement setup for a fiber optic sensor according to embodiments described herein, and for a method for monitoring according to embodiments described herein, respectively;

In the drawings, identical reference numerals designate identical or functionally identical components or steps.

### WAYS TO IMPLEMENT THE INVENTION

Hereinafter, detailed reference is made to various embodiments of the invention, with one or more examples being depicted in the drawings.

The present invention is used for predicting icing on wind turbines of one or more wind farms, and for forecasting yield losses due to icing events. Ice formation on blades of a wind turbine can lead to the fact that the turbine must be stopped or delivers less yield. This may depend on the location (e.g. official requirements often require a stop at minimum ice build-up) and the severity of icing (in case of a strong ice build-up, the turbine must be slowed down or stopped so as to avoid strong loads). A prediction of the ice accumulation enables a more accurate yield forecast with all of the advantages resulting therefrom.

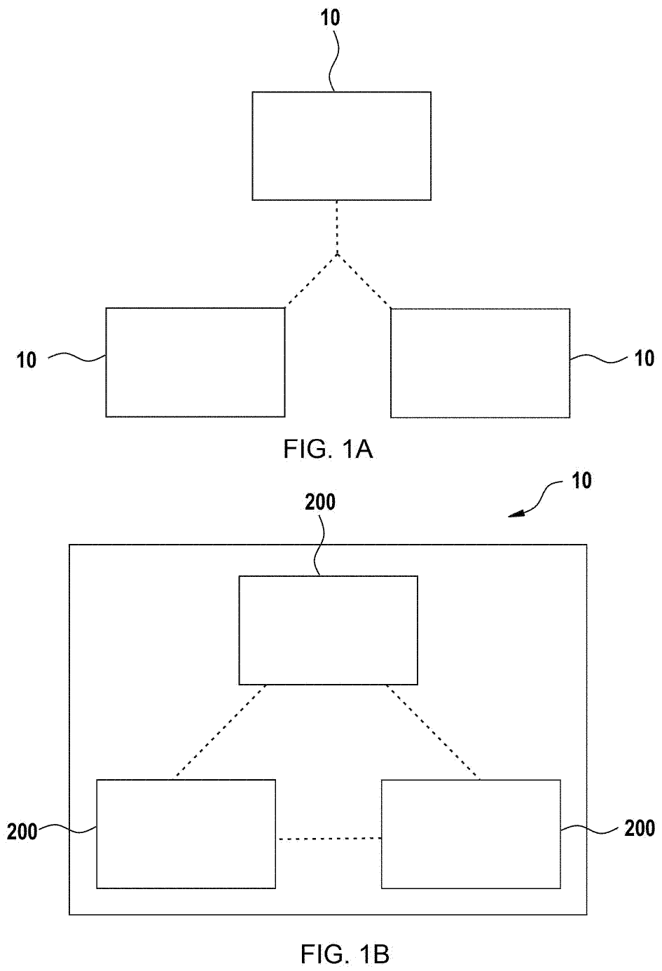

FIG. 1A schematically shows by way of example three wind farms 10 according to embodiments described herein. According to described embodiments, a method may relate to at least one or more wind farms 10, in particular to ten or more wind farms such as e.g. twenty or more wind farms. The data of the wind farms may be documented centrally (dashed lines in FIG. 1A).

FIG. 1B shows one wind farm 10 composed by way of example of three wind turbines 200. As represented by dashed lines in FIG. 1B, the wind turbines 200 may be interlinked. The interlinking may enable a common monitoring, control and/or regulation of the wind turbines 200. In addition, the wind turbines 200 may also be monitored, controlled and/or regulated individually. According to embodiments described herein, a wind farm may include one or more wind turbines, in particular five or more wind turbines such as ten or more wind turbines, for example.

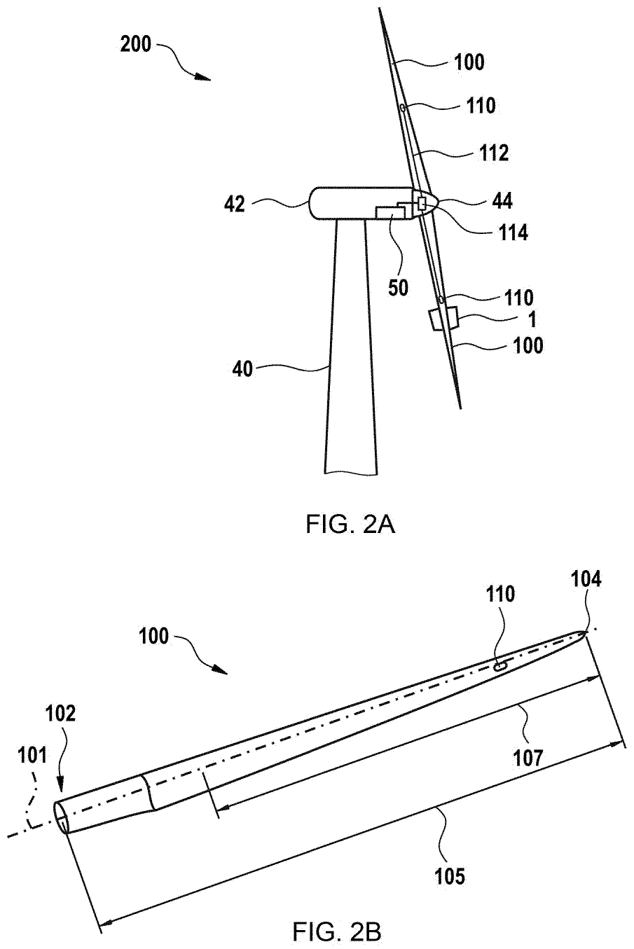

FIG. 2A shows the wind turbine 200 of a wind farm by way of example, where the method described herein may be employed. The wind turbine 200 includes a tower 40 and a nacelle 42. To the nacelle 42, the rotor is attached. The rotor includes a hub 44 to which the rotor blades 100 are attached. According to typical embodiments, the rotor has at least 2 rotor blades, in particular 3 rotor blades. During the operation of the wind turbine, the rotor, i.e. the hub together with the rotor blades, rotates about an axis. Thereby, a generator is driven for current generation. As represented in FIG. 2A, at least one sensor 110 is provided in a rotor blade 100. The sensor is in communication with an evaluation unit 114 by means of a signal line. The evaluation unit 114 delivers a signal to a control unit and/or regulation unit 50 of the wind turbine 200.

In the area of the rotor blade tip of the rotor blades 100, an ice build-up 1 is represented schematically. In the rotor blade, vibrations or accelerations, for example, are detected by means of the sensor 110 which may be formed as a vibration sensor or acceleration sensor according to described embodiments. The sensor 110 may be in the form of electrical and/or fiber optic sensors, for example. The sensors may be configured for measuring ice masses, for example.

FIG. 2B shows a rotor blade 100 of a wind turbine. The rotor blade 100 has an axis 101 along its longitudinal extension. The length 105 of the rotor blade extends from the blade flange 102 to the blade tip 104. According to embodiments described herein, a sensor 110 is situated in an axial or radial area, i.e. an area along the axis 101.

It is often desirable to predict the ice build-up on wind turbines and/or in wind farms. This may allow a yield forecast to be given, for example. Yield forecasts may be continuously improved and specified by more accurate predictions. Furthermore, yield forecasts offer advantages both in the energy trade and the control of conventional power plants. In addition, a better scheduling of maintenance assignments is possible.

In the icing event, ice may accumulate inter alia on the rotor blades 100. The accumulation of ice or the ice build-up may be measured on turbines. The amount or volume of accumulated ice may vary between the individual turbines.

The term “accumulation of ice” or “ice build-up” such as used herein designates an increase of an ice mass on a rotor blade in the course of time. Furthermore, there may be a decrease of ice. An increase of an ice mass may be an accumulation or increase of an ice mass and thus be positive, or may be a decrease of an ice mass and thus be negative. The term “icing event” such as used herein designates the occurrence of an accumulation of ice on at least one wind turbine of a wind farm.

In the icing event, the ice masse accumulated on the rotor blades of wind turbines in a period of time may be determined. The obtained data may be designated ice build-up data. Determining an ice mass requires an appropriate measurement variable to be measured. The measurement is performed by means of sensors 110. The measurement variable may be transformed by a transformation into a system variable S. The system variable S is determined indirectly. For example, a natural oscillation of a rotor blade may be measured.

The system variable S is further associated with the mass of the rotor blade. Alternatively, or in addition, the system variable S is associated with the mass of an ice build-up on the rotor blade. Typically, the system variable S is obtained from measured data of vibration or acceleration measurements in or on one rotor blade or more of the rotor blades. In embodiments, the measurement variable is measured in the course of time of a detection period, preferably by measuring vibrations or accelerations in the course of time of the detection period T. The measurement is performed on or in the rotor blade.

The system variable S is derived from the measured data, preferably by natural frequency analysis from the measured data of the vibration or acceleration measurements. For example, a measurement system determining, for instance, a current ice build-up on the rotor blades of a wind turbine, may be installed on a plurality of wind turbines (e.g. within one or more wind farms). The system variable S is indicative of the mass of the respective rotor blade(s) and/or of the mass of ice build-up of the respective rotor blade(s). In embodiments, the system variable S is proportional to the total mass of the rotor blade and/or proportional to an additional mass layer of the rotor blade. An additional mass layer of the rotor blade is such a mass layer that is added to the net mass of the rotor blade. Typically, the system variable is proportional to the ice mass.

The measurement of the ice build-up on a rotor blade is performed in the detection period T by sensors 110. The measured data may be acquired continuously. The ice progresses of all of the wind turbines equipped with measurement systems, and, for example, current or predicted meteorological data for all wind turbine locations, for example, and further data for the current or future general weather situation, for example, may be recorded centrally. The detection period T is a measurement period continuously increasing with a constant increase in time.

A forecast period Pt is a period for which a forecast is made. For example, an ice build-up may be forecasted. The forecast period Pt may include or at least overlap the measurement period. Typically, the forecast period Pt is the measurement period plus one additional day (24 hours) into the future. This may mean that a measured value of the measurement variable can be detected at any point in time of a forecast. This may moreover enable the forecast values and the actually measured values to be continuously compared. The detection of a measured value related to a forecast for a certain point of time may be performed temporally later than the forecast as such.

The term “historical data” as used herein designates data which had been detected in a past period of time at a point of time tₓ₋ₖ, before a certain point of time tₓ or tₓ₊ₙ. Historical data are acquired and stored so that they can also be provided at a later point of time. Historical data may be data related to an ice build-up. Historical data may be meteorological data. Historical data may exist for a plurality of wind farms, in particular for each wind farm, furthermore, for a plurality of wind turbines of a wind farm, e.g. for each wind turbine of a wind farm.

The term “current data” as used herein designates the respective data representing the acquired data at a certain observation time tₓ. Current data may be the data each most recently acquired at the observation time tₓ. Current data may be data related to an ice build-up. Current data may be meteorological data. Current data may exist for a plurality of wind farms, in particular for each wind farm, furthermore for a plurality of wind turbines of a wind farm, e.g. for each wind turbine of a wind farm.

The term “predicted data” as used herein designates data originating from an arbitrary forecast model or prediction model. These may be e.g. predicted meteorological data or a predicted ice build-up. Predicted data may be related to a plurality of wind farms, in particular to each wind farm, furthermore to a plurality of wind turbines of a wind farm, e.g. for each wind turbine of a wind farm. There may be a regional location reference of the predicted data.

The term “meteorological data” as used herein may include data on the wind speed, wind direction, temperature, air humidity, air pressure and/or further weather-related parameters. Meteorological data may relate to one or more locations of wind farms. Meteorological data may in particular include the general weather situation at one or more locations. Meteorological data, in particular predicted meteorological data, may be obtained from a commercial service. Meteorological data may be further detected at a weather measuring station of a wind farm.

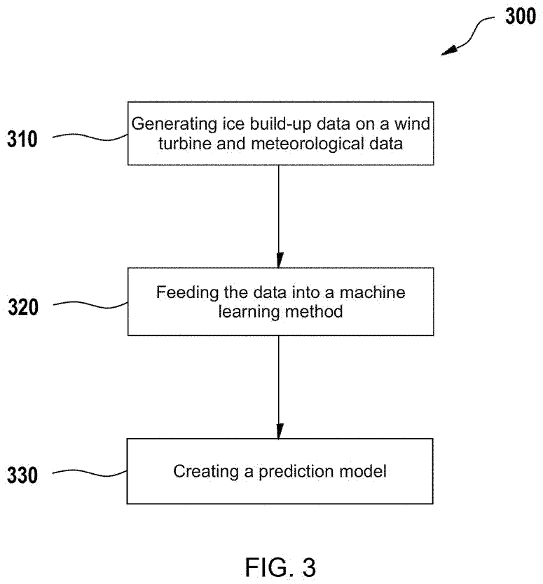

FIG. 3 shows a flow chart of a first method 300 according to embodiments described herein.

In a first step 310 of the first method, ice build-up data are detected on at least one wind turbine. According to embodiments described herein, an ice build-up measurement may be performed on one or more wind turbines. The measurement may be performed on all of the wind turbines of a wind farm. The measurement may be performed on turbines of one ore more wind farms. The measurement may be performed indirectly. The measurement may be performed continuously. The acquired data may include historical data. The acquired data may include current data.

Further, meteorological data of the wind farm where the at least one wind turbine is situated are used. Meteorological data of a plurality of wind farms may be used, in particular when data on the ice build-up on wind turbines of this plurality of wind farms are acquired. The used meteorological data may include historical data. The used meteorological data may include current data.

In a step 320 of the first method, the acquired ice build-up data are fed into a machine learning method. The fed in ice build-up data may be data of one wind turbine. Further, they may be data of a plurality of wind turbines. Further, they may be data of all of the wind turbines. The historical ice build-up data may be fed in. The current ice accumulation data may be fed in.

Further, the used meteorological data are fed into the machine learning method. For example, the entirety of data acquired over a prolonged period of time is used in a machine learning method. The fed in meteorological data may be data related to one wind farm. Further, they may be data related to a plurality of wind farms. The historical meteorological data may be fed in. The current meteorological data may be fed in. Predicted meteorological data may be fed into the machine learning method. All of the acquired and used data of all of the wind turbines of all of the wind farms may be fed in.

A machine learning method such as used herein is an artificial system learning from examples and generalizing these learning phases after completion. This implies recognizing patterns and laws in the fed in or input data. The practical implementation is performed by algorithms. It is in particular a monitored learning method. In a monitored learning method, a «teacher» indicates the correct or best corresponding output pattern/values to the input pattern/values. Thus, after a repeated presentation of the corresponding input and output pattern, the model is able to perform and generalize this association independently, viz. to do this also for unknown, similar input patterns.

In a step 330, a prediction model is created. The prediction model is based on the machine learning method. The prediction model is based, for example, on a monitored learning method. The model may be a continuously improving, probabilistic model. For example, from the fed in data, the prediction model may predict a future icing intensity for a wind turbine. For example, historical ice build-up measurements and meteorological data are used so as to learn a probabilistic model for predicting the ice build-up on all turbines. This model may be used to determine the future ice build-up on all of the observed wind turbines based on current and past ice build-up measurements and current, past or predicted meteorological data.

A forecast model or prediction model such as used herein may be, for example, a numerical, data based forecast model. The prediction model is based on the machine learning method. By means of the prediction model, for example, the future ice build-up may be predicted for a wind turbine from the fed in data. Due to the determined model, for example, the future ice build-up may be predicted from current and historical data (including meteorological predictions). Since there are measured data on the actual ice progress on the wind turbines, a monitored learning method may be used. The probabilistic model resulting therefrom allows, for example, the icing intensity and uncertainty per wind turbine to be predicted.

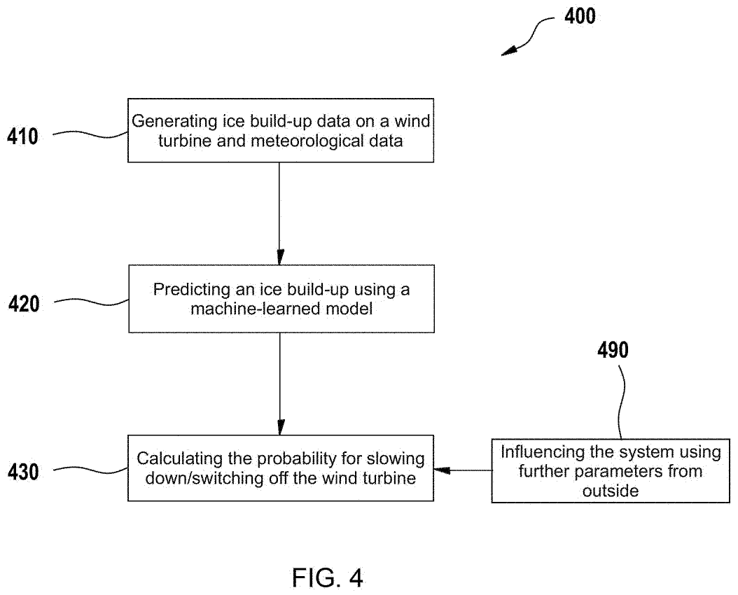

FIG. 4 shows a flow chart of a second method 400 according to embodiments described herein.

In a step 410 of the second method, ice build-up data are acquired on at least one wind turbine. According to embodiments described herein, an ice build-up measurement may be performed on one or more wind turbines. The measurement may be performed on all of the wind turbines of a wind farm. The measurement may be performed on turbines of one or more wind farms. The measurement may be performed indirectly. The measurement may be performed continuously. The acquired data may include historical data. The acquired data may include current data.

Further, meteorological data of the wind farm where the at least one wind turbine is situated are used. Meteorological data of a plurality of wind farms may be used, in particular when data on the ice build-up on wind turbines of this plurality of wind farms are acquired. The used meteorological data may include historical data. The used meteorological data may include current data.

In a step 420, an ice build-up is predicted. For example, the icing intensity and/or the mass of ice to be expected may be predicted. The prediction is based on a prediction model. For example, the prediction of the ice build-up may be based on the prediction model described with reference to FIG. 3. The ice build-up may be predicted for one location. The location may include a plurality of wind farms. The ice build-up may be predicted in addition for one wind farm. Further, the ice build-up may be predicted for a plurality of wind turbines of one wind farm. The ice build-up may be predicted for one wind turbine of a wind park.

The prediction may include an uncertainty. This uncertainty is a non-negative parameter characterizing the distribution of those values which are assigned to the prediction on the basis of the information used.

In a step 430, a probability for slowing down and/or switching off a wind turbine is calculated. Depending on the turbine location and the general conditions resulting therefrom, a probability may be determined that the turbine may be switched off or slowed down. This depends e.g. on official requirements, the type of turbine and the icing intensity to be expected. The probability that a turbine may be stopped or slowed down may be used to correspondingly correct a yield forecast that is based on meteorological data.

The slowing down and/or switching off is based e.g. on the predicted ice build-up. A wind turbine may be slowed down, for instance, when the ice build-up on a turbine reaches a threshold value Sp. Further, a wind turbine is switched off, when the ice build-up on a turbine e.g. reaches a threshold value S_{A}.

The threshold value S_{D} such as used herein is a threshold value for the amount of accumulated ice, which is suitable for the system variable S, and upon which the turbine reaching the threshold value is slowed down. The threshold value S_{D}, for example, is a defined limit value for an amount of accumulated ice, e.g. the mass and/or the volume of accumulated ice, upon which, when it is exceeded, the wind turbine is slowed down. The slowing down describes the negative acceleration of the rotor blades to a reduced number of rotations. The threshold value S_{D} may be determined empirically, for example. A slowing down of rotor blades must be performed, for example, when a faster rotation of the rotor blades would lead to damages.

Furthermore, a condition for switching off a wind turbine due to an amount of accumulated ice impairing the operation can be defined by a threshold value S_{A}, which is suitable for the system variable S. The threshold value S_{A}, for example, is a defined limit value for an amount of accumulated ice, e.g. the mass and/or the volume of accumulated ice, upon which, when it is exceeded, a concerned wind turbine is switched off. The threshold value S_{A} is higher than the threshold value S_{D}. A turbine that had been previously slowed down may subsequently reach the threshold value S_{A}. The previously slowed down turbine is then switched off. The threshold value S_{A} may be determined empirically, for example. The switching off of a turbine must be performed, for example, when continuing a slowed down state or a normal state of the wind turbine would lead to considerable damages and/or safety problems.

The probability of a future slowing down and/or switching off for one or more wind turbines is dictated by the ice build-up predicted for the turbines. The ice build-up may also be predicted for the wind farm.

In a step 490, further parameters or general condition influencing the system are detected. Such parameter may be e.g. the location of the turbine, official rules and/or limitations caused by the material. The parameters may enter into the system in the form of threshold values. These parameters will be included in the calculation of the probability for slowing down and/or stopping the turbine. The probability for slowing down and/or stopping the turbine e.g. may thereby be specified. For example, an official requirement could require the turbine to be stopped at a lower icing intensity than the material of the rotor blade.

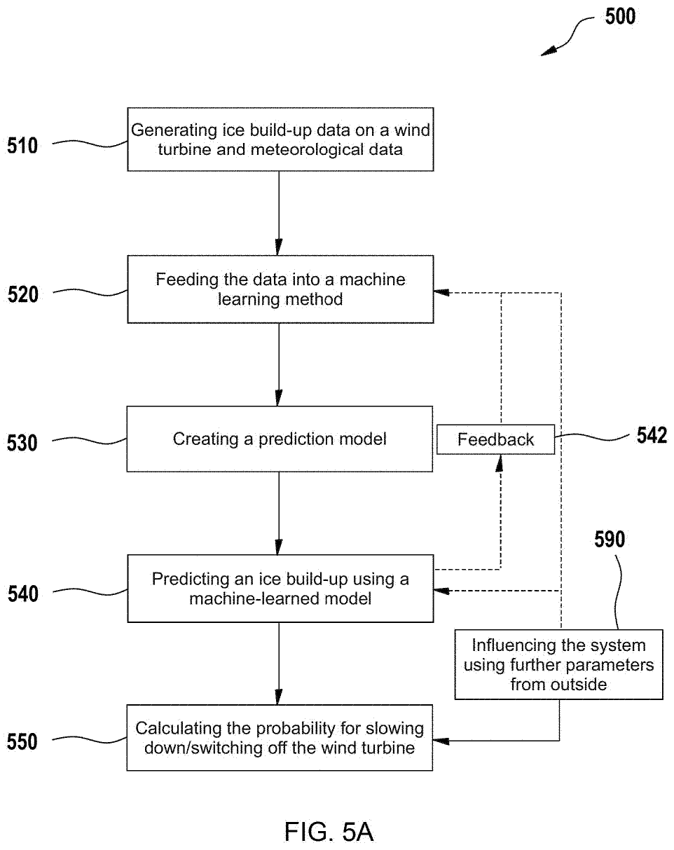

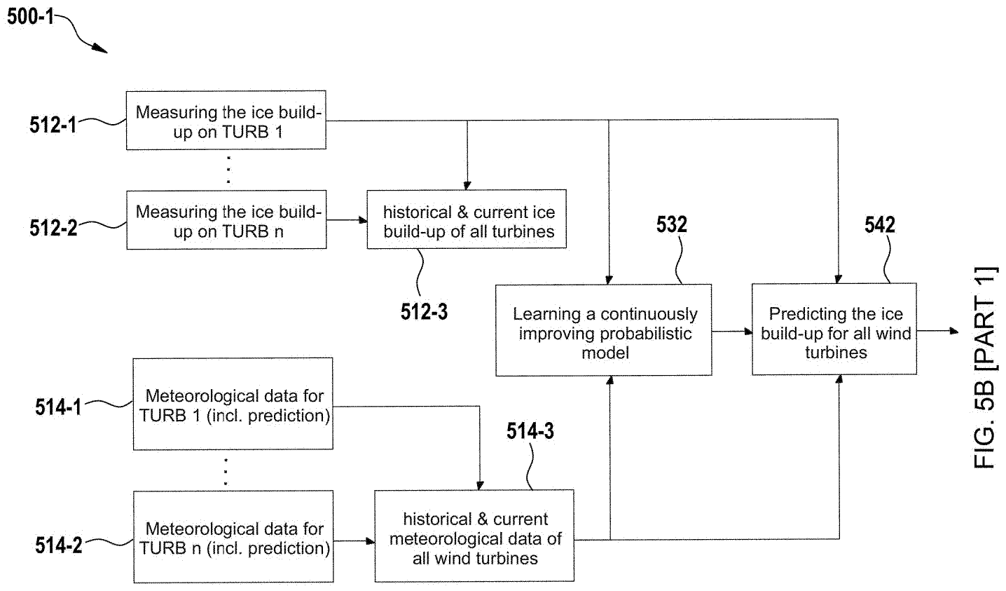

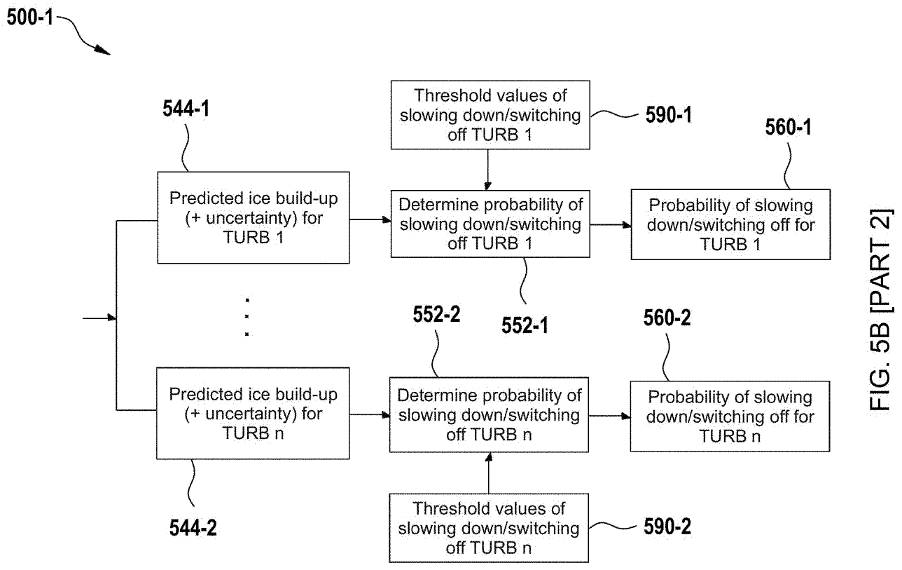

FIG. 5A shows a flow chart of a method 500 according to embodiments described herein. FIG. 5B shows a flow chart of a method 500-1 according to embodiments described herein.

In a step 510 of the method, ice build-up data are acquired on at least one wind turbine. According to embodiments described herein, an ice build-up measurement may be performed on one or more wind turbines. For example, the measurement according to step 512-1 of the ice build-up is performed on turbine 1. According to step 512-2, the measurement may be performed on n turbines. “n” is in this case the number of turbines. By way of example, “n” wind turbines of one wind farm or of different wind farms may be included. According to step 512-3, historical and current data for an ice build-up of all of the wind turbines may be the result. A measurement may be performed on all of the wind turbines of a wind farm. The measurement may be performed on turbines of one or more wind farms. The measurement may be performed indirectly. The measurement may be performed continuously. The acquired data may include historical data. The acquired data may include current data.

Further, meteorological data of the wind farm are used where the at least one wind turbine is situated. Meteorological data of a plurality of wind farms may be used, in particular when data of the build-up are acquired on wind turbines of this plurality of wind farms. Meteorological data related to the wind turbine 1 as shown in step 514-1 may be used. Meteorological data related to n wind turbines as shown in step 514-2 may be used. The used data may include historical data. The used data may include current data. The used data may include predicted meteorological data.

In a step 520, the acquired and used data are fed into a machine learning method. According to embodiments, the fed in data may both be ice build-up data and meteorological data. Both data sets may include historical, current and predicted data. The machine learning method may be e.g. the learning method of step 320 of the method 300. A continuously improving probabilistic model such as e.g. according to step 532 may be learned.

In a step 530, a prediction model is created. The prediction model is based on the machine learning method. The learning method is a monitored learning method. Current measured values may serve as a «teacher» for inputting correct output values to the input value(s). These may be ice build-up data, meteorological data or both of them. A continuous improvement of the model may mean, for example, that already predicted data will be matched to the data actually measured at the respective point of time in the future.

In a step 540, an ice build-up is predicted by means of a machine learned model. According to step 542, the prediction of the ice build-up may be performed for all wind turbines. The prediction of the ice build-up may be performed for one wind farm. The prediction of the ice build-up may be performed for a plurality of wind farms. An amount of the accumulated ice may be predicted, which may be, for example, the mass and/or the volume of the ice. The predicted ice amount may be integrated into step 520. This may be performed e.g. in step 542. As described above, the predicted ice build-up may include an uncertainty. According to step 544-1, a build-up may already be predicted for wind turbine 1. According to a step 544-2, a build-up for n wind turbines may be predicted.

In a step 550, the probability for slowing down/switching off the wind turbine is determined. A probability for slowing down/switching off the wind turbine 1 may be determined according to a step 552-1, for example. According to a step 552-2, the probability of slowing down/switching off n wind turbines may be determined in addition. The slowing down and/or switching off of the wind turbines may be based on the current ice build-up. Furthermore, the slowing down and/or switching off may be based on the predicted ice build-up. The slowing down and/or switching off may be based on both of them.

In a step 560-1, the probability of slowing down/switching off is obtained for wind turbine 1. In a step 560-2, the probability of slowing/down/switching off n wind turbines is obtained in addition. These probabilities allow a yield forecast to be established. An accurate yield forecast is important to be able to calculate the performance of a wind turbine, a wind farm and/or a plurality of wind farms in advance.

The probability calculation of step 550 may be influenced by further parameters from outside. From these, threshold values e.g. for ice amounts may be derived. Further parameters may be official rules, for example. According to a step 590-1, threshold values may exist that influence the slowing down/switching off of wind turbine 1. According to a step 590-2, threshold values may further exist that influence the slowing down/switching off of n wind turbines. These parameters may be included into the learning method. Furthermore, the parameters may be included into the prediction of an ice build-up.

As already indicated in the course of step 520, both the predicted and the currently measured ice build-up data may in turn be fed into the monitored learning method by means of a feedback 542.

The calculated probability for slowing down and/or switching off the wind turbine may be used to create a yield forecast. The yield forecast may be valid for a plurality of wind farms. It may in particular be valid for one wind farm. Furthermore, a yield forecast may be valid for a plurality of wind turbines, in particular for one wind turbine. A yield forecast may be constantly improved and specified by the predictions.

As compared to yield forecasts merely based on meteorological data, the ice build-up may be explicitly included into the consideration. This enables standstill times caused by ice build-up on wind turbines to be forecast in a considerably more accurate manner. As compared to the ice prediction based on merely meteorological data, there is a benefit from measuring the actual icing on the wind turbines. This allows the prediction to be continuously improved, on the one hand. Hereby, the current icing state is exactly known, on the other hand, which allows a more accurate forecast to be made, since the future change of the ice build-up may be strongly dependent on the current icing state of the rotor blades. In addition, this method allows the connection in the ice formation between different turbines to be determined. Thus, there may be wind turbines within one farm, for example, which always ice up first because they are more exposed, or turbines of a wind farm ice up before turbines of another farm ice up (depending on the general weather situation).

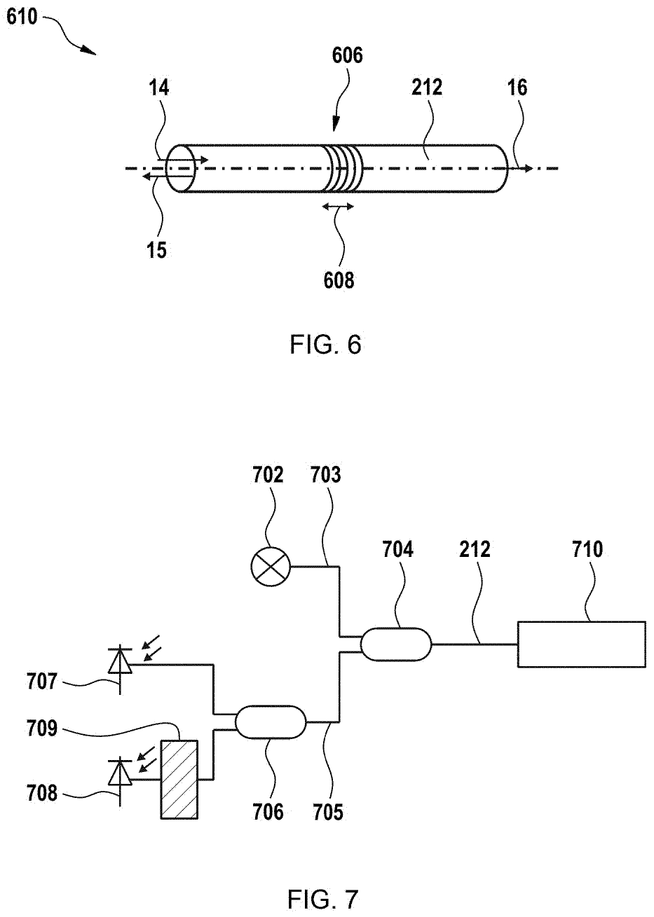

FIG. 6 schematically shows a light conductor with a fiber Bragg grating for use in sensors according to embodiments described herein.

FIG. 6 shows a sensor or fiber optic sensor 610 integrated into a light conductor including a fiber Bragg grating 606. Although only one single fiber Bragg grating 606 is shown in FIG. 6, it is to be understood that the present invention is not restricted to acquire data from a single fiber Bragg grating 606, but that along a light conductor 212, a transmission fiber, a sensor fiber or an optical fiber, a plurality of fiber Bragg gratings 606 may be arranged.

FIG. 6 thus only shows a portion of an optical waveguide formed as a sensor fiber, optical fiber or light conductor 212, wherein this sensor fiber is sensitive to fiber elongation (see arrow 608). Here, it should be pointed out that the expression “optical” or “light” should be indicative of a wavelength range in the electromagnetic spectrum, which may extend from the ultraviolet spectral range via the visible spectral range up to the infrared spectral range. A center wavelength of the fiber Bragg grating 606, i.e. a so-called Bragg wavelength AB, is obtained by the following equation:

λB=2·nk·∧.

In this case, nk is the effective refractive index of the basic mode of the core of the optical fiber, and ∧ is the spatial grating period (modulation period) of the fiber Bragg grating 606.

A spectral width given by the fill width at half-height of the reflection response depends on the extension of the fiber Bragg grating 606 along the sensor fiber. Due to the action of the fiber Bragg grating 606, the light propagation within the sensor fiber or the light conductor 212 thus is dependent, for example, on forces, moments and mechanical tensions, as well as temperatures which are applied to the sensor fiber, i.e. the optical fiber and in particular the fiber Bragg grating 606 within the sensor fiber.

As shown in FIG. 6, electromagnetic radiation 14 or primary light enters from the left into the optical fiber or the light conductor 212, with a part of the electromagnetic radiation 14 exiting as a transmitted light 16 with a changed wavelength progress as compared to the electromagnetic radiation 14. Furthermore, it is possible for reflected light 15 to be received at the input end of the fiber (i.e. at the end where also the electromagnetic radiation 14 is irradiated), the reflected light 15 likewise having a modified wavelength distribution. The optical signal used for detecting and evaluating may be provided according to the embodiments described herein by the reflected light, the transmitted light, as well as a combination of both of them.

In a case, in which the electromagnetic radiation 14 or the primary light is irradiated in a wide spectral range, there will be a transmission minimum in the transmitted light 16 at the place of the Bragg wavelength. In the reflected light, there will be a reflection maximum at this place. A detection and evaluation of the intensities of the transmission minimum or the reflection maximum, or of intensities in corresponding wavelength ranges, will generate a signal that can be evaluated with respect to the length change of the optical fiber or the light conductor 212, and thus is indicative of forces or vibrations.

FIG. 7 shows a typical measurement system for evaluating fiber optic and other acceleration sensors. The system has a source 702 of electromagnetic radiation, for example, a primary light source. The source serves to provide optical radiation, by means of which at least one fiber optic sensor element of a sensor, for example, an acceleration sensor, may be irradiated. For this purpose, an optical transmission fiber or a light conductor 703 is provided between the primary light source 702 and a first fiber coupler 704. The fiber coupler couples the primary light into the optical fiber or the light conductor 212. The source 702, for example, may be a broadband light source, a laser, an LED (light emitting diode), an SLD (superluminescence diode), an ASE light source (amplified spontaneous emission light source), or an SOA (semiconductor optical amplifier). For embodiments described herein, several sources of the same or different type (see above) may also be used.

The fiber optic sensor element 710 such as, for example, a fiber Bragg grating (FBG) or an optical resonator, is integrated into a sensor fiber or optically coupled to the sensor fiber. The light reflected by the fiber optic sensor elements in turn is guided via the fiber coupler 704 which guides the light via the transmission fiber 705 into a beam splitter 706. The beam splitter 706 splits the reflected light for the detection by means of a first detector 707 and a second detector 708. In this case, the signal detected on the second detector 708 is first filtered by an optical edge filter 709.

The edge filter 709 allows a shift of the Bragg wavelength at the FBG or a wavelength change due to the optical resonator to be detected. In general, a measurement system such as illustrated in FIG. 6 may be provided without the beam splitter 706 or detector 707. The detector 707, however, enables the measured signal of the acceleration sensor to be standardized with respect to other intensity fluctuations, such as, for example, fluctuations of the intensity of the source 702, fluctuations by reflections at interfaces between individual light conductors, or other intensity fluctuations. This standardization improves the measurement accuracy and reduces the dependence of measurement systems on the length of the light conductors provided between the evaluation unit and the fiber optic sensor.

In particular, when several FBGs are used, additional optical filtering means (not shown) may be used for filtering the optical signal or secondary light. An optical filtering means 709 or additional optical filtering means may comprise an optical filter selected from the group consisting of a thin film filter, a fiber Bragg grating, an LPG, an arrayed waveguide grating (AWG), an Echelle grating, a grating arrangement, a prism, an interferometer, and any combination thereof.

While the present invention has been described using typical exemplary embodiments, it is not restricted thereto but can be modified in manifold ways. The invention is neither restricted to the mentioned options of use. Further, it should be pointed out here, that the aspects and embodiments described herein may be appropriately combined with each other, and that single aspects may be omitted where it is reasonable and possible within the scope of expertise action. The skilled person is familiar with modifications and additions of the aspects described herein.

1. A method for creating a prediction model for ice build-up on wind turbines, comprising:
detecting current ice build-up data at at least one wind turbine, wherein the current ice build-up data are determined by at least one vibration sensor or at least one acceleration sensor;
using current and historical meteorological data for the location of the at least one wind turbine;
feeding in the current ice build-up data and historical ice-build up data of the at least one wind turbine and feeding in the current and historical meteorological data in a machine learning method; and
creating a prediction model based on the machine learning method;
wherein at least one probability of a probability of slowing down or a probability of switching off of the at least one wind turbine is predicted.

2. (canceled)

3. The method for creating a prediction model for ice build-up on wind turbines according to claim 1, wherein the machine learning method is a monitored learning method.

4. A method for predicting ice build-up on wind turbines, comprising:
detecting current ice build-up data at at least one wind turbine, wherein the current ice build-up data are determined by at least one vibration sensor or at least one acceleration sensor;
using current and historical meteorological data for the location of the at least one wind turbine;
using the current ice build-up data and historical ice build-up data;
predicting an ice build-up based on a machine learned model; and
predicting at least one probability of a probability of slowing down or a probability of switching off of the at least one wind turbine.

5. The method for predicting ice build-up on wind turbines according to claim 4, wherein at least one selected from the group consisting of a probability of a slowing down and a probability of a switching off is calculated based on the prediction of the ice build-up and on location-contingent general conditions.

6. The method for predicting ice build-up on wind turbines according to claim 4, wherein the machine learned model is created by
detecting current ice build-up data at at least one wind turbine, wherein the current ice build-up data are determined by at least one vibration sensor or at least one acceleration sensor;
using current and historical meteorological data for the location of the at least one wind turbine, wherein the current and historical meteorological data comprise at least two of the group consisting of wind speed, wind direction, temperature, air humidity, air pressure and further weather-related parameters; and
feeding in the current ice build-up data and historical ice-build up data of the at least one wind turbine and feeding in the current and historical meteorological data in the machine learning method.

7. The method for predicting ice build-up on wind turbines according to claim 4, wherein the meteorological data include predicted meteorological data.

8. The method for predicting ice build-up on wind turbines according to claim 4, wherein an icing intensity is predicted by the prediction.

9. (canceled)

10. Use of the method for creating a prediction model for ice build-up on wind turbines according to claim 1 for creating a yield forecast for at least one of the group consisting of wind farms and the at least one wind turbine.
